(19) United States
(12) Patent Application Publication
(10) Pub. No.: US 2022/0032771 A1
(43) Pub. Date: Feb. 3, 2022

(54) STOP RANGE INDICATION DEVICE AND METHOD FOR VEHICLE

(71) Applicants: HYUNDAI MOTOR COMPANY, Seoul (KR); KIA MOTORS CORPORATION, Seoul (KR)

(72) Inventors: Seok Hwan CHOI, Seoul (KR); Ho Kyun CHUN, Seoul (KR); Jae Sung BANG, Yongin-si (KR)

(73) Assignees: HYUNDAI MOTOR COMPANY, Seoul (KR); KIA MOTORS CORPORATION, Seoul (KR)

(21) Appl. No.: 17/101,364

(22) Filed: Nov. 23, 2020

(30) Foreign Application Priority Data
Aug. 3, 2020 (KR) 10-2020-0096895

(51) Int. Cl. B60K 35/00; G09G 5/38

(52) U.S. Cl. CPC B60K 35/00; G09G 5/38; B60K 2370/179; B60K 2370/52; G09G 2380/10; B60K 2370/177; B60K 2370/21; G09G 2340/0464; B60K 2370/1529

(57) ABSTRACT

A stop range indication device and a stop range indication method for a vehicle are proposed. The device and the method calculate an estimated stop range of a host vehicle using a variety of pieces of information during deceleration traveling of the host vehicle and provide visual guidance to a driver by displaying a stop range ahead of the host vehicle in accordance to the result of the calculation, thereby enabling the driver to drive safely while recognizing the stop range ahead of the host vehicle.

### CROSS REFERENCE TO RELATED APPLICATION

The present application claims priority to and the benefit of Korean Patent Application No. 10-2020-0096895, filed on Aug. 3, 2020, the entire contents of which is incorporated herein by reference.

### FIELD

The present disclosure relates generally to a stop range indication device and method for a vehicle.

### BACKGROUND

The statements in this section merely provide background information related to the present disclosure and may not constitute prior art.

As is well known in the art, during traveling of a vehicle, deceleration is performed when the foot is detached from the accelerator pedal, and the vehicle is decelerated and stops when the brake pedal is pressed.

Specialized functions of electric vehicles include a one-foot driving function enabling a vehicle to be accelerated or stop.

For reference, the one-foot driving function is also referred to as one-pedal driving.

Thus, when the one-foot driving function (also referred to as one-pedal driving) is executed, the vehicle is accelerated by the driver pressing the accelerator pedal and is decelerated and stops by the driver detaching the foot from the accelerator pedal.

For example, when the one-foot driving function is executed, the vehicle is gradually decelerated and stops as in a case in which the driver is not pressing the accelerator pedal after having driven the vehicle at 20 kph.

However, when the one-foot driving function is executed, the driver may feel anxious for not pressing the brake pedal by him or herself. In addition, the driver may feel anxious due to the uncertainty of a position where and a point in time at which the vehicle is to stop.

In contrast, in a vehicle having an internal combustion engine (ICE), when the accelerator pedal is not pressed, the vehicle is only decelerated to a minimum speed but does not stop unless the brake pedal is pressed.

However, since the braking operation executed by the driver pressing the brake pedal depends on the driver's sense of determination of a distance to a vehicle, a stop line, an obstacle, or the like ahead of the driver's vehicle, there may be uncertainty or the like in the position where and the point in time at which the vehicle is to stop.

The foregoing is intended merely to aid in the understanding of the background of the present disclosure, and is not intended to mean that the present disclosure falls within the purview of the related art that is already known to those skilled in the art.

### SUMMARY

The present disclosure provides a stop range indication device and method for a vehicle, the device and the method being able to calculate an estimated stop range of a host vehicle using a variety of pieces of information during deceleration traveling of the host vehicle and provide visual guidance to a driver by displaying a stop range ahead of the host vehicle in accordance to the result of the calculation, so that the driver may drive safely while recognizing the stop range ahead of the host vehicle.

According to one aspect of the present disclosure, there is provided a stop range indication device for a vehicle, the device including: an information providing unit configured to provide vehicle information used for estimation of a stop range of a host vehicle; a controller configured to calculate the stop range ahead of the host vehicle in response to deceleration traveling of the host vehicle, in accordance with the vehicle information provided by the information providing unit; and a display unit configured to receive a stop range calculation signal from the controller and display the stop range ahead of the host vehicle as an augmented reality (AR) image.

The information providing unit may include: a radar sensor configured to sense a distance to a preceding vehicle; a velocity change sensor configured to detect a rate of change of velocity of the host vehicle; a speed sensor configured to detect a current speed of the host vehicle; an accelerator pedal sensor configured to output an ON signal when a driver has pressed an accelerator pedal; a brake pedal sensor configured to output an ON signal when the driver has pressed the brake pedal; a steering angle sensor detecting an angle at which the driver has operated the steering wheel; and a one-foot drive control provided adjacent to a driver's seat.

The controller may include: a velocity change calculator configured to calculate the rate of change of velocity of the host vehicle; a stop estimator configured to estimate whether or not the host vehicle is to stop; a stop range calculator configured to calculate the stop range ahead of the host vehicle; an obstacle determiner configured to determine whether or not an obstacle is present ahead of the host vehicle; a stop range transmitter configured to transmit a stop range signal regarding the stop range calculated by the stop range calculator to the display unit; a traveling condition change determiner configured to determine whether or not to re-execute the calculation of the stop range in accordance with a change in the vehicle information provided by the information providing unit; and a stop determiner configured to determine that the host vehicle is in a stopped state and control the display unit to stop displaying the stop range.

The velocity change calculator may provide the stop estimator with a velocity change signal regarding the rate of change of velocity of the host vehicle sensed by the velocity change sensor or a velocity change signal generated by differentiating a speed of the host vehicle transmitted by the speed sensor.

When a magnitude of deceleration provided by the velocity change calculator is equal to or greater than a predetermined value, the stop estimator may estimate that the host vehicle will stop and notify the stop range calculator to start the calculation of the stop range.

The stop range calculator may calculate the stop range ahead of the host vehicle using the formula:

$$S = \frac{1}{2} ( \frac{{v}^{2}}{{a}_{2}} - \frac{{v}^{2}}{{a}_{1}} ) ,$$

where v indicates a current speed of the host vehicle, a₁ indicates a minimum value of deceleration for stopping the host vehicle, and a₂ indicates a maximum value of deceleration for stopping the host vehicle.

When the stop range ahead of the host vehicle calculated by the stop range calculator is located in a position beyond a distance to a preceding vehicle sensed by the radar sensor and overlaps a preceding vehicle or is located in a position beyond a position of a traffic light or a stop line transmitted by a navigation device and overlaps the traffic light or the stop line, the obstacle determiner may determine that the obstacle is present ahead of the host vehicle.

When an ON signal generated by the accelerator pedal sensor or an ON operation signal generated by the one-foot drive control, from among the vehicle information provided by the information providing unit, is received or a steering angle signal generated by the steering angle sensor is received, the traveling condition change determiner may determine to re-execute the calculation of the stop range and then transmit a determination signal to the stop range calculator, the determination signal indicating the calculation of the stop range to be re-executed.

The display unit may include: a camera capturing an image ahead of the host vehicle; a head-up display provided on a windshield of the host vehicle; a projector projecting the AR image representing the stop range ahead of the host vehicle onto the head-up display; and a display controller configured to receive a stop range calculation signal from the controller, determine a position where the AR image of the stop range is to be displayed from the image ahead of the host vehicle captured by the camera, and perform a control operation of sending a command signal to the projector to project the AR image of the stop range in accordance with the determined position onto the head-up display.

According to one aspect of the present disclosure, there is provided a stop range indication method for a vehicle, the method including: obtaining, by the information providing unit, vehicle information used for estimation of a stop range of a host vehicle; calculating, by the controller, the stop range ahead of the host vehicle in response to deceleration traveling of the host vehicle, in accordance with the vehicle information provided by the information providing unit; and receiving, by the display unit, a stop range calculation signal from the controller and displaying, by the display unit, the stop range ahead of the host vehicle as an AR image.

The calculation of the stop range ahead of the host vehicle may be performed using the formula:

$$S = \frac{1}{2} ( \frac{{v}^{2}}{{a}_{2}} - \frac{{v}^{2}}{{a}_{1}} ) ,$$

where v indicates a current speed of the host vehicle, a₁ indicates a minimum value of deceleration for stopping the host vehicle, and a₂ indicates a maximum value of deceleration for stopping the host vehicle. The calculation of the stop range ahead of the host vehicle may be performed after the rate of change of velocity of the host vehicle has been calculated and, when a magnitude of deceleration is equal to or greater than a predetermined value, the host vehicle has been estimated to stop.

The minimum value of deceleration a₁ and the maximum value of deceleration a₂ used for the calculation of the stop range may be corrected by calculating an error between the stop range in a previous stopped state and the stop range in a current stopped state.

The stop range indication method may further include: determining, by an obstacle determiner of the controller, whether or not an obstacle is present in the stop range ahead of the host vehicle calculated by the stop range calculator.

The determination of whether or not the obstacle is present may determine that the obstacle is present ahead of the host vehicle when the stop range ahead of the host vehicle calculated by the stop range calculator is located in a position beyond a distance to a preceding vehicle sensed by a radar sensor and overlaps the preceding vehicle or is located in a position beyond a position of a traffic light or a stop line transmitted by the navigation device and overlaps the traffic light or the stop line.

The displaying of the stop range ahead of the host vehicle as the AR image may include: determining a position where the AR image of the stop range is to be displayed from an image captured from an range ahead of the host vehicle; and projecting, by a projector, the AR image representing the stop range in accordance with the determined position onto a head-up display.

When a determination signal indicating presence of an obstacle ahead of the host vehicle is transmitted to the display controller by an obstacle determiner, the head-up display may display a portion overlapping between the stop range and the obstacle as an AR image having a warning color, under control of the display controller.

When the controller receives one of an ON signal generated by the accelerator pedal sensor and an ON operation signal generated by the one-foot drive control, from among the vehicle information provided by the information providing unit, or a steering angle signal generated by the steering angle sensor, re-execution of the calculation of the stop range may be determined.

The stop range indication method may further include, when the host vehicle is determined to be in a stopped state, stopping the display unit displaying the stop range.

The present disclosure having the above-described forms provides the following effects.

First, even in the case that a one-foot driving function (also referred to as one-pedal driving) of an electric vehicle is executed, the AR image of the stop range ahead of the host vehicle may be displayed on a display unit (e.g. a head-up display) in the host vehicle to visually guide a driver. Accordingly, the driver's anxiety resulting from not pressing the brake pedal by him or herself may be overcome, and the driver may be sure of a position where and a point in time at which the host vehicle is to stop.

Second, even in the case of an electric vehicle or an internal combustion engine (ICE) vehicle, visual guidance may be provided to the driver by displaying the AR image of the stop range ahead of the host vehicle on the display unit (e.g. the head-up display), so that the driver may recognize an accurate point in time at which the brake pedal is to be pressed, thereby inhibiting a sudden braking operation or the like and promoting safe driving.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The above and other objectives, features, and other advantages of the present disclosure will be more clearly understood from the following detailed description when taken in conjunction with the accompanying drawings, in which:

FIG. 1 is a block diagram illustrating one form of a configuration of a stop range indication device for a vehicle according to the present disclosure;

FIG. 2 is a graph illustrating one form of a method of calculating the stop range ahead of a host vehicle by the stop range indication device for a vehicle according to the present disclosure;

FIG. 3 is a schematic view illustrating an example in which the stop range is displayed as an AR image on the head-up display by the stop range indication device for a vehicle according to the present disclosure;

FIG. 4 is a schematic view illustrating an example in which a warning AR image in which the stop range overlaps an obstacle is displayed on the head-up display by the stop range indication device for a vehicle according to the present disclosure; and

FIG. 5 is a flowchart illustrating one form of a stop range indication method for a vehicle according to the present disclosure.

The drawings described herein are for illustration purposes only and are not intended to limit the scope of the present disclosure in any way.

### DETAILED DESCRIPTION

Hereinafter, various forms of the present disclosure will be described in detail with reference to the accompanying drawings.

As publicly known in the art, some of exemplary forms may be illustrated in the accompanying drawings from the viewpoint of function blocks, units and/or modules. Those skilled in the art will understood that such blocks, units and/or modules are physically implemented by electronic (or optical) circuits such as logic circuits, discrete components, processors, hard wired circuits, memory devices and wiring connections. When the blocks, units and or modules are implemented by processors or other similar hardware, the blocks, units and modules may be programmed and controlled through software (for example, codes) in order to perform various functions discussed in the present disclosure. Furthermore, each of the blocks, units and/or modules may be implemented by dedicated hardware or a combination of dedicated hardware for performing some functions and a processor for performing another function (for example, one or more programmed processors and related circuits).

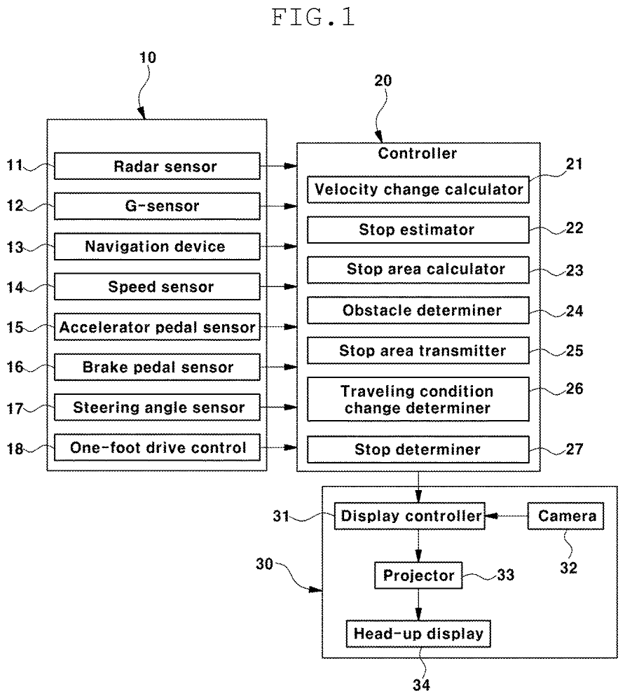

In the accompanying drawings, FIG. 1 is a block diagram illustrating the configuration of a stop range indication device for a vehicle according to the present disclosure.

As illustrated in FIG. 1, the stop range indication device for a vehicle according to the present disclosure includes: an information providing unit 10 providing vehicle information used for the estimation of a stop range of a host vehicle; a controller 20 calculating the stop range ahead of the host vehicle in response to deceleration traveling of the host vehicle, on the basis of the vehicle information provided by the information providing unit 10; and a display unit 30 receiving a stop range calculation signal from the controller 20 and displaying the stop range ahead of the host vehicle as an augmented reality (AR) image.

The information providing unit 10 includes: a radar sensor 11 sensing a distance to a preceding vehicle (i.e. a vehicle ahead of the host vehicle); a velocity change sensor 12 detecting a rate of change of velocity of the host vehicle; a navigation device 13 providing information regarding traffic lights, stop lines, obstacles, and the like ahead of the host vehicle; a speed sensor 14 detecting a current speed of the host vehicle; an accelerator pedal sensor 15 outputting an ON signal when the driver has pressed the accelerator pedal; a brake pedal sensor 16 outputting an ON signal when the driver has pressed the brake pedal; a steering angle sensor 17 detecting an angle at which the driver has operated the steering wheel; and the like.

In addition, the information providing unit 10 may further include a one-foot drive control 18 provided adjacent to the driver's seat. When the one-foot drive control 18 is operated, a one-foot driving function, such as gear shifting and acceleration or deceleration adjustment, may be performed.

For example, the one-foot drive control 18 may include an audio, video, and navigation (AVN) system, a switch separately mounted adjacently to the driver's seat, a paddle shifter mounted on the steering wheel, or the like.

According to this configuration, when the driver performs an operation by, for example, selecting a one-foot driving control menu disposed on a monitor of the AVN system, pressing the switch, or pressing the paddle shifter, the one-foot driving function also referred to as “one-pedal driving” may be executed.

The controller 20 includes: a velocity change calculator 21 calculating the rate of change of velocity of the host vehicle; a stop estimator 22 estimating whether or not the host vehicle is to stop; a stop range calculator 23 calculating the stop range ahead of the host vehicle; an obstacle determiner 24 determining whether or not an obstacle is present ahead of the host vehicle; a stop range transmitter 25 transmitting a stop range signal regarding the stop range calculated by the stop range calculator 23 to the display unit 30; a traveling condition change determiner 26 determining whether or not to re-execute the calculation of the stop range on the basis of a change in the vehicle information provided by the information providing unit 10; a stop determiner 27 determining that the host vehicle is in a stopped state; and the like.

The velocity change calculator 21 provides the stop estimator 22 with a velocity change signal regarding the rate of change of velocity of the host vehicle sensed by the velocity change sensor 12 or a velocity change signal generated by differentiating the speed (e.g. a wheel speed) of the host vehicle transmitted by the speed sensor 14.

The stop estimator 22 is configured to estimate whether or not the host vehicle will stop, on the basis of a deceleration signal provided by the velocity change calculator 21 and a vehicle speed signal transmitted by the speed sensor 14 or on the basis of the deceleration signal provided by the velocity change calculator 21 and the ON signal transmitted by the brake pedal sensor 16, and to notify the stop range calculator 23 that the calculation of the stop range has started.

For example, in a case in which the one-foot driving function is executed, when the current speed of the host vehicle is equal to or smaller than a predetermined speed and the magnitude of the deceleration is equal to or greater than a predetermined value, the stop estimator 22 estimates that the host vehicle will stop and notifies the stop range calculator 23 to start the calculation of the stop range.

In contrast, in a case in which the host vehicle is an internal combustion engine (ICE) vehicle, when the magnitude of the deceleration due to the coasting of the host vehicle is equal to or greater than the predetermined value or the magnitude of the deceleration due to temporal operation of the brake pedal is equal to or greater than the predetermined value, the stop estimator 22 estimates that the host vehicle will stop and notifies the stop range calculator 23 to start the calculation of the stop range.

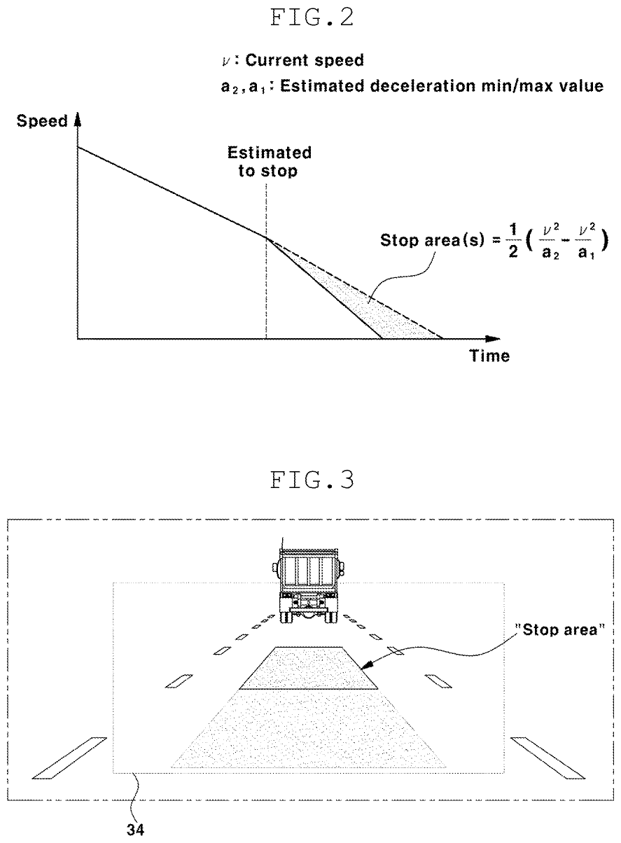

When the stop estimator 22 estimates that the host vehicle will stop, the stop range calculator 23 calculates the stop range (i.e. the range where the host vehicle will finally stop) ahead of the host vehicle from a point in time at which the host vehicle is estimated to stop, as illustrated in FIG. 2, using Formula 1:

$$S = \frac{1}{2} ( \frac{{v}^{2}}{{a}_{2}} - \frac{{v}^{2}}{{a}_{1}} ) , \qquad ( 1 )$$

where v indicates the current speed of the host vehicle, a₁ indicates a minimum value of deceleration for the stopping of the host vehicle, and a₂ indicates a maximum value of deceleration for the stopping of the host vehicle.

Here, the minimum value of deceleration a₁ and the maximum value of deceleration a₂ may be corrected by pattern learning of the stop range.

For example, the minimum value of deceleration a₁ and the maximum value of deceleration a₂ may be corrected by calculating the error between the stop range in the previous stopped state and the stop range in the current stopped state.

When the stop range ahead of the host vehicle calculated by the stop range calculator 23 is located in a position beyond a distance to the preceding vehicle sensed by the radar sensor 11 and overlaps a preceding vehicle or is located in a position beyond the position of a traffic light or a stop line transmitted by the navigation device 13 and overlaps the traffic light or the stop line, the obstacle determiner 24 determines that the obstacle is present ahead of the host vehicle.

The stop range transmitter 25 transmits the stop range signal calculated by the stop range calculator 23, i.e. a command signal instructing the display unit 30 to display the stop range ahead of the host vehicle, to the display unit 30.

When the ON signal generated by the accelerator pedal sensor 15 in response to the driver pressing the accelerator pedal or an ON operation signal generated in response to the driver operating the one-foot drive control 18, from among the vehicle information provided by the information providing unit 10, is received or a steering angle signal generated by the steering angle sensor 17 in response to the driver turning the steering wheel is received, the traveling condition change determiner 26 determines to re-execute the calculation of the stop range, and then, transmits a determination signal to the stop range calculator 23, the determination signal indicating the calculation of the stop range to be re-executed.

In a case in which the one-foot driving function is executed in an electric vehicle, when the speed of the host vehicle is less than the predetermined speed, or in the case of an ICE vehicle, when the ON signal generated by the brake pedal sensor 16 is received for at least a predetermined reference (e.g. time, strength, or number), the stop determiner 27 determines that the host vehicle has stopped in the stop range or the like and transmits a command signal to the display unit 30 to stop displaying the stop range.

The display unit 30 includes a display controller 31, a camera 32, a head-up display 34, and a projector 33. The display controller 31 receives a stop range calculation signal from the controller 20 and performs a series of control operations to display the stop range ahead of the host vehicle as an AR image. The camera 32 captures an image from a range ahead of the host vehicle. The head-up display 34 is provided on the windshield disposed in front of the driver of the host vehicle. The projector 33 projects the AR image representing the stop range ahead of the host vehicle onto the head-up display 34.

The display controller 31 determines a position where the AR image of the stop range is to be displayed in the image ahead of the host vehicle captured by the camera 32 and performs a control operation of sending the command signal to the projector 33 to project the AR image of the stop range in accordance with the determined position onto the head-up display 34.

In this manner, as illustrated in FIG. 2, the head-up display 34 provides visual guidance to the driver by displaying the AR image of the stop range to overlap the road ahead of the host vehicle. Accordingly, the driver's anxiety resulting from not pressing the brake pedal by him or herself in a situation in which the one-foot driving function (also referred to as the one-pedal driving) is being executed may be overcome, and the driver may be sure of the position where and the point in time at which the host vehicle is to stop.

In addition, even in the case of an ICE vehicle, when the host vehicle is decelerating, as illustrated in FIG. 3, the head-up display 34 may provide visual guidance to the driver by displaying the AR image of the stop range to overlap the road ahead of the host vehicle, so that the driver may recognize an accurate point in time at which the brake pedal is to be pressed, thereby inhibiting a sudden braking operation or the like and promoting safe driving.

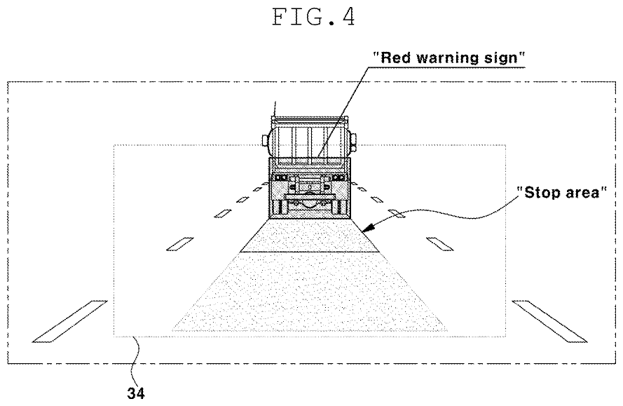

In addition, as described above, when the stop range is located beyond the distance to the preceding vehicle and overlaps the preceding vehicle or is located beyond the position of a traffic light or a stop line and overlaps the traffic light or the stop line, the obstacle determiner 24 determines that the obstacle is present ahead of the host vehicle. The obstacle determiner 24 generates a determination signal, which in turn the controller 20 transmits to the display controller 31. Then, as illustrated in FIG. 4, the head-up display 34 displays a portion overlapping between the stop range and the obstacle (e.g. the preceding vehicle) as an AR image having a warning color (e.g. red), under the control of the display controller 31.

Consequently, the driver may see the AR image having the warning color (e.g. red) displayed on the head-up display 34 and recognize a situation in which the stop range ahead of the host vehicle overlaps the obstacle (e.g. the preceding vehicle), thereby rapidly performing a braking operation to maintain the distance to the obstacle.

For example, the driver may maintain a safety distance to the obstacle by rapidly pressing the brake pedal while releasing the one-foot driving function of the electric vehicle. In the ICE vehicle, the driver may maintain the safety distance to the obstacle by rapidly pressing the brake pedal.

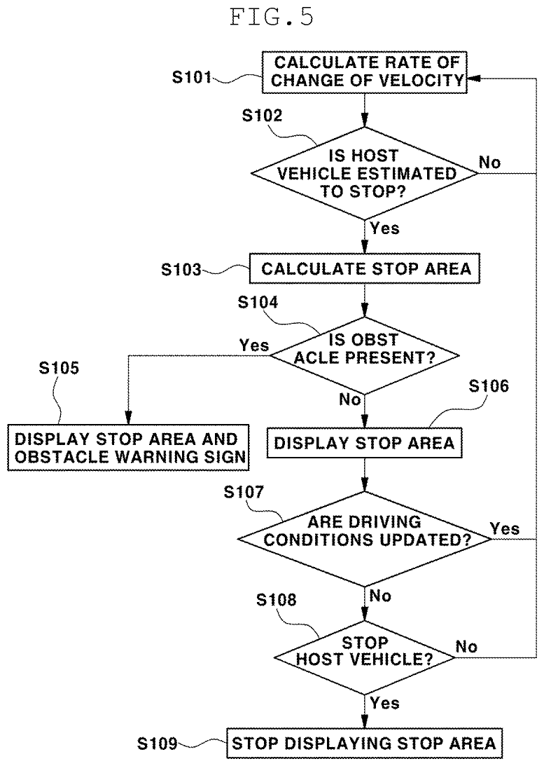

Hereinafter, the stop range indication method for a vehicle according to the present disclosure, on the basis of the above-described configuration, will be sequentially described with reference to a flowchart in FIG. 5.

The stop range indication method for a vehicle according to the present disclosure includes the following steps of: providing, by the information providing unit 10, vehicle information used for the estimation of a stop range of a host vehicle to the controller 20; calculating, by the controller 20, the stop range ahead of the host vehicle in response to deceleration traveling of the host vehicle, on the basis of the vehicle information provided by the information providing unit 10; and receiving, by the display unit 30, a stop range calculation signal from the controller 20 and displaying, by the display unit 30, the stop range ahead of the host vehicle as an AR image.

In this regard, first, the velocity change calculator 21 of the controller 20 calculates the current rate of change of velocity of the host vehicle in S101.

For example, the velocity change calculator 21 receives the velocity change signal regarding the rate of change of velocity of the host vehicle directly from the velocity change sensor 12 or calculates the velocity change signal generated by differentiating the speed (e.g. a wheel speed) of the host vehicle transmitted by the speed sensor 14.

Subsequently, the stop estimator 22 of the controller 20 estimates whether or not the host vehicle is to stop in S102.

The stop estimator 22 estimates that the host vehicle is to stop on the basis of a deceleration signal regarding current deceleration of the host vehicle calculated by the velocity change calculator 21 and a vehicle speed signal transmitted by the speed sensor 14 or the deceleration signal provided by the velocity change calculator 21 and an ON signal transmitted by the brake pedal sensor 16.

For example, in a case in which the one-foot driving function (also referred to as the one-pedal driving) is executed, when the current speed of the host vehicle is equal to or smaller than a predetermined speed and the magnitude of the deceleration is equal to or greater than a predetermined value, the stop estimator 22 estimates that the host vehicle will stop.

In contrast, in a case in which the host vehicle is an ICE vehicle, when the magnitude of the deceleration due to the coasting of the host vehicle is equal to or greater than the predetermined value or the magnitude of the deceleration due to temporal operation of the brake pedal is equal to or greater than the predetermined value, the stop estimator 22 estimates that the host vehicle will stop.

Afterwards, when the stop estimator 22 estimates that the host vehicle will stop, the stop range calculator 23 of the controller 20 calculates the stop range ahead of the host vehicle (i.e. the range where the host vehicle will finally stop) using Formula 1 in S103.

That is, the step of calculating, by the stop range calculator 23, the stop range ahead of the host vehicle is performed using Formula 1 after the velocity change calculator 21 has calculated the rate of change of velocity of the host vehicle and, when the magnitude of the deceleration is equal to or greater than the predetermined value, has estimated that the host vehicle will stop.

Afterwards, in S104, the obstacle determiner 24 of the controller 20 determines whether or not an obstacle is present in the stop range ahead of the host vehicle calculated by the stop range calculator 23.

For example, when the stop range is located in a position beyond the distance to the preceding vehicle, sensed by the radar sensor 11, and overlaps the preceding vehicle or is located in a position beyond the position of a traffic light or a stop line, transmitted by the navigation device 13, and overlaps the traffic light or the stop line, the obstacle determiner 24 determines that the obstacle is present ahead of the host vehicle.

In contrast, when the stop range is located in a position within the distance to the preceding vehicle sensed by the radar sensor 11 or in a position not reaching the position of the traffic light or the stop line transmitted by the navigation device 13, the obstacle determiner 24 determines that no obstacle is present ahead of the host vehicle.

Afterwards, the display unit 30 displays the AR image of the stop range on the head-up display 34 in S105 and S106.

That is, when the stop range transmitter 25 of the controller transmits the stop range signal calculated by the stop range calculator 23 to the display controller 31 of the display unit 30, the AR image of the stop range may be displayed on the head-up display 34 under the control of the display controller 31.

More specifically, the display controller 31 determines a position where the AR image of the stop range should be displayed from an image captured from an range ahead of the host vehicle and sends a command signal to the projector 33 to project the AR image of the stop range onto the head-up display 34 in accordance with the determined position, so that the projector 33 projects the AR image of the stop range onto the head-up display 34.

Thus, the head-up display 34 displays the AR image of the stop range to overlap on the road ahead of the host vehicle in S105.

Consequently, the driver may visually recognize the stop range (i.e. the position where the host vehicle is to stop) displayed as the AR image on the head-up display 34. The anxiety of the driver due to not pressing the brake pedal by him or herself in a case in which the one-foot driving function (also referred to as the one-pedal driving) is executed may be overcome. In addition, the driver may be sure of a position where and a point in time at which the host vehicle is to stop.

In addition, in the ICE vehicle, the driver may see the stop range (i.e. the position where the host vehicle is to stop) displayed as the AR image on the head-up display 34 and recognize an accurate point in time at which the brake pedal should be pressed, thereby inhibiting a sudden braking operation or the like while promoting safe driving.

In contrast, when the obstacle determiner 24 transmits the determination signal indicating the presence of the obstacle ahead of the host vehicle to the display controller 31 as described above, the head-up display 34 displays a portion overlapping between the stop range and the obstacle (e.g. the preceding vehicle) as an AR image having a warning color (e.g. red) as illustrated in FIG. 4, under the control of the display controller 31, in S106.

Consequently, the driver may see the AR image having the warning color (e.g. red) displayed on the head-up display 34 and recognize a situation in which the stop range ahead of the host vehicle overlaps the obstacle (e.g. the preceding vehicle), thereby rapidly performing a braking operation to maintain the distance to the obstacle.

According to the present disclosure, determining, by the change determiner 26 of the controller 20, whether or not driving conditions of the host vehicle have changed, i.e. driving situations of the host vehicle have been updated, is further performed in S107.

For example, when the ON signal generated by the accelerator pedal sensor 15 or the steering angle signal generated by the steering angle sensor 17, from among the vehicle information provided by the information providing unit 10, is received, the host vehicle may be in an acceleration state instead of being in a deceleration state or there may be a change in driving lanes ahead of the host vehicle. In this case, the traveling condition change determiner 26 of the controller 20 determines to re-execute the calculation of the stop range and then transmits a signal indicating the determination of the re-execution of the calculation of the stop range to the stop range calculator 23.

According to the present disclosure, when none of the driving conditions are determined to be updated as the result of the operation of determining whether or not the driving conditions have been updated, determining, by the stop determiner 27 of the controller 20, whether or not the host vehicle is to stop is further performed in S108.

For example, when the vehicle speed of the electric vehicle is less than a predetermined value or is zero (0) in a case in which the one-foot driving function (also referred to as the one-pedal driving) is executed, or when the vehicle speed of the ICE vehicle is less than a predetermined value or is 0 while the ON signal generated by the brake pedal sensor 16 is received for at least a predetermined reference (e.g. time, strength, or number), the stop determiner 27 determines that the host vehicle has stopped in the stop range or the like and transmits a command signal to the display unit 30 to stop displaying the stop range.

Consequently, the display controller 31 controls the head-up display 34 to stop displaying the AR image in S109.

Although the exemplary forms of the present disclosure have been described for illustrative purposes, those skilled in the art will appreciate that various modifications, additions and substitutions are possible, without departing from the scope and spirit of the present disclosure as disclosed in the accompanying claims.

What is claimed is:

1. A stop range indication device for a vehicle, the device comprising:
an information providing unit configured to provide vehicle information used for estimation of a stop range of a host vehicle;
a controller configured to calculate, based on the vehicle information provided by the information providing unit, the stop range ahead of the host vehicle in response to deceleration of the host vehicle; and
a display unit configured to receive a stop range calculation signal from the controller and display the stop range ahead of the host vehicle as an augmented reality image.

2. The stop range indication device of claim 1, wherein the information providing unit comprises:
a radar sensor configured to sense a distance to a preceding vehicle;
a velocity change sensor configured to detect a rate of change of velocity of the host vehicle;
a speed sensor configured to detect a current speed of the host vehicle;
an accelerator pedal sensor configured to output a first ON signal when a driver has pressed an accelerator pedal;
a brake pedal sensor configured to output a second ON signal when the driver has pressed the brake pedal;
a steering angle sensor configured to detect an angle at which the driver has operated a steering wheel; and
a one-foot drive control adjacent to a seat of the driver.

3. The stop range indication device of claim 2, further comprising a navigation device configured to provide information regarding traffic lights, stop lines, and obstacles ahead of the host vehicle.

4. The stop range indication device of claim 1, wherein the controller comprises:
a velocity change calculator configured to calculate the rate of change of velocity of the host vehicle;
a stop estimator configured to estimate whether or not the host vehicle is to stop;
a stop range calculator configured to calculate the stop range ahead of the host vehicle;
an obstacle determiner configured to determine whether or not an obstacle is present ahead of the host vehicle;
a stop range transmitter configured to transmit a stop range signal regarding the stop range calculated by the stop range calculator to the display unit;
a traveling condition change determiner configured to determine whether or not to re-execute the calculation of the stop range when the vehicle information provided by the information providing unit changes; and
a stop determiner configured to determine whether the host vehicle is in a stopped state and to control the display unit to stop displaying the stop range.

5. The stop range indication device of claim 4, wherein the velocity change calculator is configured to provide the stop estimator a velocity change signal regarding the rate of change of velocity of the host vehicle sensed by the velocity change sensor or a velocity change signal generated by differentiating a speed of the host vehicle transmitted by the speed sensor.

6. The stop range indication device of claim 4, wherein, when a magnitude of deceleration provided by the velocity change calculator is equal to or greater than a predetermined value, the stop estimator is configured to estimate that the host vehicle will stop and notifies the stop range calculator to start the calculation of the stop range.

7. The stop range indication device of claim 4, wherein the stop range calculator is configured to calculate the stop range ahead of the host vehicle using the formula:
$$S = \frac{1}{2} ( \frac{{v}^{2}}{{a}_{2}} - \frac{{v}^{2}}{{a}_{1}} ) ,$$
wherein v indicates a current speed of the host vehicle, a₁ indicates a minimum value of deceleration for stopping the host vehicle, and a₂ indicates a maximum value of deceleration for stopping the host vehicle.

8. The stop range indication device of claim 4, wherein, when the stop range ahead of the host vehicle calculated by the stop range calculator is located in a position beyond a distance to a preceding vehicle sensed by the radar sensor and overlaps a preceding vehicle, or
when the stop range ahead of the host vehicle is located in a position beyond a position of a traffic light or a stop line transmitted by a navigation device, and overlaps the traffic light or the stop line,
the obstacle determiner is configured to determine that the obstacle is present ahead of the host vehicle.

9. The stop range indication device of claim 4, wherein when an ON signal generated by the accelerator pedal sensor or an ON operation signal generated by the one-foot drive control, is received or when a steering angle signal generated by the steering angle sensor is received,
the traveling condition change determiner is configured to determine whether to re-execute the calculation of the stop range and then to transmit a determination signal to the stop range calculator, the determination signal indicating the calculation of the stop range to be re-executed.

10. The stop range indication device of claim 1, wherein the display unit comprises:
a camera configured to capture an image ahead of the host vehicle;
a head-up display on a windshield of the host vehicle;
a projector configured to project the augmented reality image representing the stop range ahead of the host vehicle onto the head-up display; and
a display controller configured to:
receive a stop range calculation signal from the controller,
determine a position where the augmented reality image of the stop range is to be displayed from the image ahead of the host vehicle captured by the camera, and
send a command signal to the projector to project the augmented reality image of the stop range in accordance with the determined position onto the head-up display.

11. A stop range indication method for a vehicle, the method comprising:
obtaining, by an information providing unit, vehicle information used for estimation of a stop range of a host vehicle;
calculating, by the controller, the stop range ahead of the host vehicle in response to deceleration of the host vehicle, based on the vehicle information provided by the information providing unit;
receiving, by the display unit, a stop range calculation signal from the controller; and
displaying, by the display unit, the stop range ahead of the host vehicle as an augmented reality image.

12. The stop range indication method of claim 11, wherein calculating the stop range ahead of the host vehicle is performed after the rate of change of velocity of the host vehicle has been calculated and, when a magnitude of deceleration is equal to or greater than a predetermined value, the host vehicle has been estimated to stop.

13. The stop range indication method of claim 11, wherein calculating the stop range ahead of the host vehicle is performed using the formula:
$$S = \frac{1}{2} ( \frac{{v}^{2}}{{a}_{2}} - \frac{{v}^{2}}{{a}_{1}} ) ,$$
wherein v indicates a current speed of the host vehicle, a₁ indicates a minimum value of deceleration for stopping the host vehicle, and a₂ indicates a maximum value of deceleration for stopping the host vehicle.

14. The stop range indication method of claim 13, wherein the minimum value of deceleration a₁ and the maximum value of deceleration a₂ used for the calculation of the stop range are corrected by calculating, by the controller, an error between the stop range in a previous stopped state and the stop range in a current stopped state.

15. The stop range indication method of claim 11, the method further comprising:
determining, by an obstacle determiner of the controller, whether or not an obstacle is present in the stop range ahead of the host vehicle calculated by a stop range calculator.

16. The stop range indication method of claim 15, wherein determining whether or not the obstacle is present comprises:
determining that the obstacle is present ahead of the host vehicle when the stop range ahead of the host vehicle is located in a position beyond a distance to a preceding vehicle sensed by a radar sensor and overlaps the preceding vehicle; and
determining that the obstacle is present ahead of the host vehicle when the stop range ahead of the host vehicle is located in a position beyond a position of a traffic light or a stop line transmitted by a navigation device and overlaps a traffic light or a stop line.

17. The stop range indication method of claim 11, wherein displaying of the stop range ahead of the host vehicle as the augmented reality image comprises:
determining a position where the augmented reality image of the stop range is to be displayed from an image captured from a range ahead of the host vehicle; and
projecting, by a projector, the augmented reality image representing the stop range in accordance with the determined position onto a head-up display.

18. The stop range indication method of claim 17, wherein when a determination signal indicating presence of an obstacle ahead of the host vehicle is transmitted to a display controller by an obstacle determiner, the head-up display displays a portion overlapping between the stop range and the obstacle as an augmented reality image having a warning color under control of the display controller.

19. The stop range indication method of claim 11, wherein when the controller receives one of an ON signal generated by the accelerator pedal sensor and an ON operation signal generated by the one-foot drive control, or a steering angle signal generated by the steering angle sensor, re-execution of the calculation of the stop range is determined.

20. The stop range indication method of claim 11, the method further comprising:
when the host vehicle is determined to be in a stopped state, transmitting, by a controller, a signal to stop the display unit displaying the stop range.
